(19) United States
(12) Patent Application Publication
(10) Pub. No.: US 2016/0144318 A1
(43) Pub. Date: May 26, 2016

(54) SYSTEM AND METHOD FOR CONTROLLING CONDITIONS FOR ENTRY INTO FUEL CUT MODE

(71) Applicant: HYUNDAI MOTOR COMPANY, Seoul (KR)

(72) Inventors: Mu Young CHOI, Suwon-si (KR); Seung Beom YOO, Gunpo-si (KR); Jae Hoon JOUNG, Seoul (KR)

(73) Assignee: HYUNDAI MOTOR COMPANY, Seoul (KR)

(21) Appl. No.: 14/721,562

(22) Filed: May 26, 2015

(30) Foreign Application Priority Data
Nov. 26, 2014 (KR) 10-2014-0166262

(51) Int. Cl. B01D 53/94; F02D 41/02

(52) U.S. Cl. CPC B01D 53/9495; F02D 41/024

(57) ABSTRACT

A system for controlling a condition for entry into a fuel cut mode comprises a controller that receives a temperature of a catalyst in a catalytic converter and determines whether the temperature is within a temperature range in which the catalyst is activated, wherein the controller changes a condition for entry into the fuel cut mode according to the temperature.

### CROSS REFERENCE TO RELATED APPLICATION

The present application claims the benefit of priority to Korean Patent Application Number 10-2014-0166262 filed on Nov. 26, 2014, the entire content of which is incorporated herein by reference.

### TECHNICAL FIELD

The present disclosure generally relates to a system and method for controlling conditions for entry into a fuel cut mode. More particularly, the present disclosure relates to a system and method for controlling conditions for entry into a fuel cut mode based on whether the temperature of a catalyst is within a temperature range in which the catalyst is activated.

### BACKGROUND

Noxious gases found in vehicle exhaust may cause respiratory disorders, and are leading causes of both photochemical smog and global warming. Accordingly, regulations on noxious gases emitted from vehicles have been tightened globally.

In Korea, the ‘Special Act on Seoul Metropolitan Air quality Improvement’ has been in effect since Jan. 1, 2005. Its purpose is to reduce noxious exhaust gases from low-emission vehicles such as Hybrid Electric Vehicles (HEV) to meet the level set by the Ultra Low Emission Vehicle (ULEV) standard or the level set by the Super Ultra Low Emission Vehicle (SULEV) standard.

Recently, to comply with regulations on exhaust gases according to the SULEV standard, hardware aspects of a vehicle such as an injector, a catalyst, a spark plug, and the like have been changed. Also, various systems for reducing exhaust gas by cooperative control between an Electronic Control Unit (ECU) of an engine and a Hybrid Control Unit have been developed and applied to vehicles.

To meet the level of the SULEV standard especially, it is important to reduce NOₓ among exhaust gases. Results of exhaust gas tests indicate that a large amount of NOₓ is emitted after entering a fuel cut mode.

This is because three-way catalysts for purifying exhaust gas are excessively charged with oxygen due to excessively lean operating conditions in a fuel cut situation. Accordingly, NOₓ filtration efficiency is reduced.

Consequently, to meet the level set by the ULEV and SULEV standards, the present disclosure provides a system and method for controlling conditions for entry into a fuel cut mode that variably controls conditions for entering a fuel cut mode according to the temperature of the catalyst, whereby it is possible to comply with NOₓ regulations and to improve fuel efficiency.

The foregoing is intended merely to aid in the understanding of the background of the present disclosure, and is not intended to mean that the present disclosure falls within the purview of the related art that is already known to those skilled in the art.

### SUMMARY OF THE DISCLOSURE

An aspect of the present inventive concept provides a system and method for controlling conditions for entry into a fuel cut mode to improve fuel efficiency and to comply with NOₓ regulations by varying conditions for entering a fuel cut mode according to the temperature of a catalyst inside a catalytic converter.

A system for controlling conditions for entry into a fuel cut mode is described.

The system is configured to include a controller that receives a temperature of a catalyst in a catalytic converter and determines whether the temperature is within a temperature range in which the catalyst may be activated, and the controller may change a condition for entry into a fuel cut mode according to the catalyst temperature.

The controller may store both a minimum temperature and a maximum temperature in which the catalyst may be activated, and may determine whether the catalyst temperature is in between the minimum temperature and the maximum temperature.

The controller may store a reference engine RPM for entering a fuel cut mode, and adjust the reference engine RPM after determining whether the catalyst temperature is within a temperature range in which the catalyst may be activated.

The controller may decrease the reference engine RPM stored in the controller when the catalyst temperature is within a temperature range in which the catalyst may be activated, and may increase the reference engine RPM stored in the controller when the catalyst temperature is outside of the temperature range in which the catalyst is activated.

A method for controlling conditions for entry into a fuel cut mode is described.

The method includes measuring the temperature of a catalyst inside a catalytic converter; determining whether the measured catalyst temperature is within a temperature range in which the catalyst is activated; and changing a condition for entry into a fuel cut mode of a vehicle according to whether the measured catalyst temperature is within the temperature range in which the catalyst may be activated.

Changing the conditions for entry into the fuel cut mode may include adjusting the reference engine RPM for entering the fuel cut mode. The reference engine RPM may be decreased if the measured catalyst temperature is within a temperature range in which the catalyst may be activated, and the reference engine RPM may be increased if the measured catalyst temperature is outside of the temperature range in which the catalyst may be activated.

According to the system and method for controlling conditions for entry into a fuel cut mode as described above, it is possible to improve fuel efficiency and to comply with NOₓ regulations by controlling the conditions for entry into a fuel cut mode depending on the catalyst temperature.

### BRIEF DESCRIPTION OF THE DRAWINGS

The above and other aspects, features, and other advantages of the present disclosure will be more clearly understood from the following detailed description taken in conjunction with the accompanying drawings, in which:

FIG. 1 is a block diagram illustrating the whole structure of a system for controlling conditions for entry into a fuel cut mode according to the present disclosure;

FIG. 2 is a schematic diagram of a catalytic converter equipped with a catalyst temperature sensor; and

FIG. 3 is a flow diagram illustrating a method for controlling conditions for entry into a fuel cut mode according to the present disclosure.

### DETAILED DESCRIPTION

Hereinafter, embodiments of a system and method for controlling conditions for entry into a fuel cut mode according to the present disclosure will be described referring to the accompanying drawings.

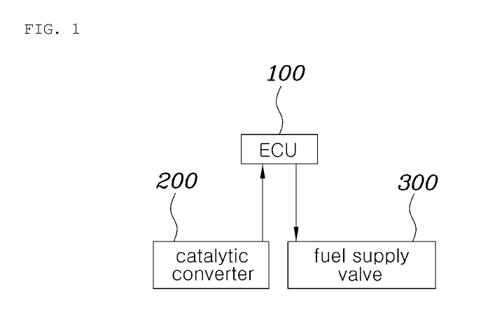

FIG. 1 is a block diagram illustrating the whole structure of a system for controlling conditions for entry into a fuel cut mode according to the present disclosure. As shown in FIG. 1, the present disclosure includes a controller 100 and a catalyst temperature sensor 400 installed in a catalytic converter 200.

Catalyst temperature may be measured using the catalyst temperature sensor 400. The catalyst temperature may also be calculated using a model temperature value previously stored in the controller 100.

The controller 100 may be configured as an ECU, and the controller 100 may determine whether the catalyst temperature of a motor vehicle is within a temperature range in which the catalyst may be activated.

In one embodiment, the controller 100 determines whether the temperature is within a temperature range in which the catalyst is activated to effectively occlude NOₓ.

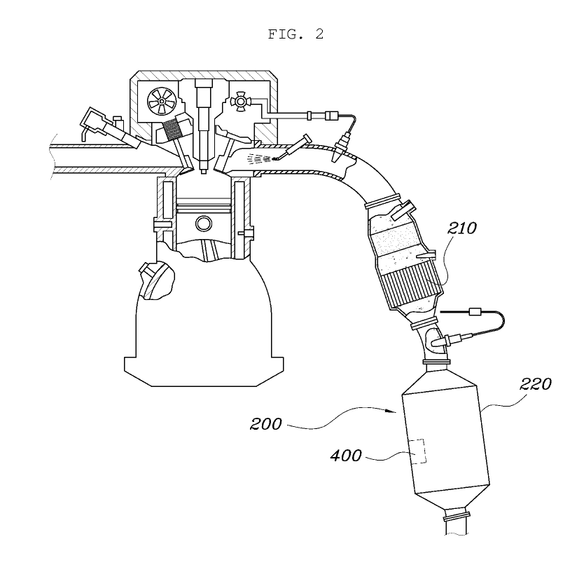

The catalyst temperature sensor 400 is installed in the catalytic converter 200 as shown in FIG. 2.

The catalytic converter 200 may be divided into a warm-up catalytic converter (WCC) 210 and an underflow catalytic converter (UCC) 220. In one embodiment, the catalyst temperature sensor of the present disclosure is installed inside the underflow catalytic converter (UCC) 220 to measure the catalyst temperature in real time. However, as described above, the catalyst temperature may be calculated using the model temperature value stored in the controller 100.

When the catalyst temperature sensor 400 installed in the underflow catalytic converter (UCC) 220 measures the catalyst temperature in real time and transmits the measured value to the controller 100, the controller 100 determines whether the value is within a temperature range in which the catalyst may be activated. According to this determination, the controller changes a condition for entry into a fuel cut mode and controls a fuel supply valve 300.

The controller 100 stores the minimum and maximum temperature in which the catalyst may be activated, and determines whether the catalyst temperature is within a temperature range for occluding NOₓ. If the catalyst temperature is within the temperature range, the controller determines whether NOₓ may be occluded at the current temperature of the catalyst or if the NOₓ occluding capability is low at the current temperature because the temperature is outside of the temperature range for occluding NOₓ.

The fuel cut control shuts off fuel to an engine to improve fuel efficiency, to prevent overheating of a catalyst while driving, and to prevent a breakdown of the engine due to high-speed rotation of the engine when braking while driving. In one embodiment, a throttle valve is completely closed as though the engine brake were activated, and if the engine RPM is higher than a predetermined value, it is determined that no more fuel is needed and the fuel supply is shut off. In addition, in determining whether to enter a fuel cut mode, the necessary engine RPM is determined through detecting conditions such as the gear level of the transmission, the air conditioning load, the temperature of the engine coolant, and the like.

However, in the case of a vehicle in which the throttle valve is electronically controlled, the throttle valve is not completely closed, but remains partially open to allow an amount of air necessary for idle travel of the vehicle to be injected.

Consequently, the reference engine RPM, which is the most important factor in determining whether to enter the fuel cut mode, is stored in the controller 100 according to the present disclosure. The controller 100 adjusts the reference engine RPM after determining whether the catalyst temperature, which is measured by the catalyst temperature sensor 400 or calculated using the previously stored model temperature value, is within a temperature range in which the catalyst may be activated.

In conventional methods, which do not reflect the fact that the catalyst temperature varies according to the driving state of the vehicle, the reference engine RPM for determining whether to enter the fuel cut mode is fixed. Therefore, these methods have difficulty meeting the ULEV and SULEV standards concerning regulations on exhaust gases.

In order to meet the ULEV and SULEV standards, the present disclosure measures the catalyst temperature of a driving vehicle in real time, and then changes the conditions for entry into a fuel cut mode based on the measured value.

In one embodiment of the present inventive concept, when the catalyst temperature measured by the catalyst temperature sensor 400 or calculated using the stored model temperature value is within the temperature range for activating the catalyst, the controller 100 decreases the stored reference engine RPM. On the other hand, when the temperature measured by the catalyst temperature sensor 400 is outside of the temperature range in which the catalyst may be activated, the controller 100 increases the stored reference engine RPM.

In other words, when the catalyst temperature of a driving vehicle is within a temperature range in which NOₓ may be occluded, it is determined that NOₓ can be sufficiently occluded even if the reference engine RPM for entering a fuel cut mode is lowered. Accordingly, the likelihood that the vehicle will enter the fuel cut mode is increased.

On the other hand, when the catalyst of the driving vehicle is not activated because the catalyst temperature is outside of the temperature range in which NOₓ may be occluded, it is determined that the NOₓ occluding capability is low. Therefore, the likelihood that the vehicle will enter the fuel cut mode is decreased, and thus NOₓ emission may be reduced.

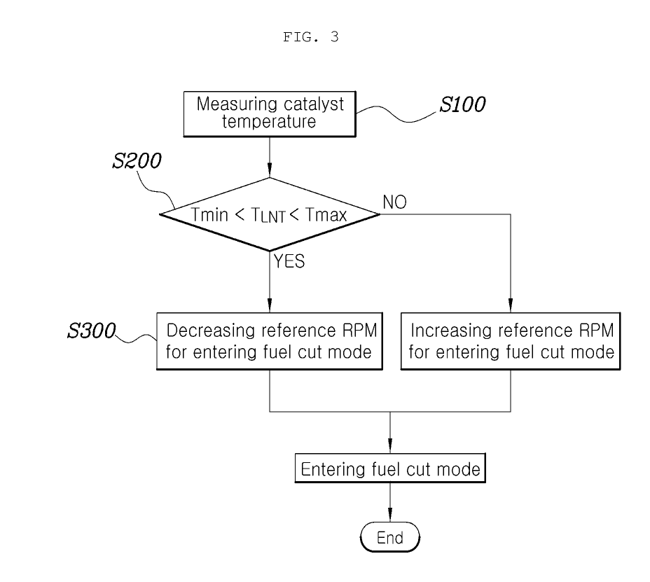

FIG. 3 is a flow diagram illustrating a method for controlling conditions for entry into a fuel cut mode according to the present disclosure. As shown in FIG. 3, the present disclosure includes: measuring temperature of a catalyst in a catalytic converter 200 (S100); determining whether the measured catalyst temperature is within a temperature range in which the catalyst may be activated (S200); and changing a condition for entry into a fuel cut mode of a vehicle according to whether the measured temperature is within the range in which the catalyst may be activated (S300).

As described above, in the step of measuring the temperature of the catalyst in the catalytic converter 200 (S100), the catalyst temperature may be calculated using the stored model temperature value.

In the step of changing the condition for entry into a fuel cut mode (S300), the reference engine RPM for entering the fuel cut mode may be controlled. For example, when the measured catalyst temperature is within a temperature range in which the catalyst may be activated, the reference engine RPM is decreased. On the other hand, when the measured catalyst temperature is outside of the temperature range in which the catalyst may be activated, the reference engine RPM is increased.

Although the embodiments of the present inventive concept have been disclosed for illustrative purposes, those skilled in the art will appreciate that various modifications, additions, and substitutions are possible without departing from the scope and spirit of the present disclosure as disclosed in the accompanying claims.

What is claimed is:

1. A system for controlling a condition for entry into a fuel cut mode, comprising:
a controller for receiving a temperature of a catalyst in a catalytic converter and for determining whether the temperature is within a temperature range in which the catalyst is activated,
wherein the controller changes the condition for entry into the fuel cut mode according to the temperature.

2. The system of claim 1, wherein the controller stores a minimum temperature and a maximum temperature in which the catalyst is activated, and determines whether the temperature is between the minimum temperature and the maximum temperature.

3. The system of claim 1, wherein the controller stores a reference engine RPM for entering a fuel cut mode, and adjusts the reference engine RPM after determining whether the temperature is within the temperature range in which the catalyst is activated.

4. The system of claim 3, wherein the controller decreases the reference engine RPM stored in the controller when the temperature is within the temperature range in which the catalyst is activated, and increases the reference engine RPM stored in the controller when the temperature is not within the temperature range in which the catalyst is activated.

5. A method for controlling an entry condition of a fuel cut mode, comprising steps of:
measuring a temperature of a catalyst in a catalytic converter;
determining whether the temperature is within a temperature range in which the catalyst is activated; and
changing a condition for entry into the fuel cut mode according to whether the temperature is within the temperature range in which the catalyst is activated.

6. The method of claim 5, wherein the step of changing the condition for entry into the fuel cut mode comprises adjusting a reference engine RPM for entering the fuel cut mode,
wherein the reference engine RPM is decreased if the temperature of the catalyst is within the temperature range in which the catalyst is activated, and is increased if the temperature of the catalyst is not within the temperature range in which the catalyst is activated.
